(19) United States
(12) Patent Application Publication
(10) Pub. No.: US 2012/0009483 A1
(43) Pub. Date: Jan. 12, 2012

(54) Negative active material for rechargeable lithium battery and rechargeable lithium battery including the same

(76) Inventors: Hee-Young Chu, Yongin-si (KR); Sung-Hwan Moon, Yongin-si (KR); Jae-Hyuk Kim, Yongin-si (KR); Jong-Seo Choi, Yongin-si (KR)

(21) Appl. No.: 12/929,207

(22) Filed: Jan. 7, 2011

(30) Foreign Application Priority Data
Jul. 6, 2010 (KR) 10-2010-0064942

(51) Int. Cl. H01M 10/0562

(52) U.S. Cl. 429/320; 429/304; 429/322; 429/319; 429/323

(57) ABSTRACT

A negative active material for a rechargeable lithium battery and a rechargeable lithium battery including the same, the negative active material including a metal-based active material; and a solid electrolyte having an ion conductivity of about 1.0×10⁻⁴ S/cm or greater.

### BACKGROUND

1. Field

Embodiments relate to a negative active material for a rechargeable lithium battery and a rechargeable lithium battery including the same.

2. Description of the Related Art

Lithium rechargeable batteries have recently drawn attention as a power source for, e.g., small portable electronic devices. They may use an organic electrolyte solution. Thus, they may have about twice the discharge voltage of conventional batteries using an alkali aqueous solution, and accordingly may have high energy density.

As positive active materials for a rechargeable lithium battery, lithium-transition element composite oxides capable of intercalating lithium, e.g., LiCoO₂, LiMn₂O₄, LiNi₁₋ₓCoₓO₂ (0<x<1), and the like, have been researched.

As negative active materials, various carbon-based materials capable of intercalating/deintercalating lithium, e.g., artificial graphite, natural graphite, and hard carbon, have been used. At present, graphite-based materials, e.g., artificial graphite and natural graphite have been widely used. Since the graphite-based negative active materials may not educe lithium metal, an internal short-circuit caused by dendrites may not occur. Thus, drawbacks originating from an internal short-circuit may not occur.

### SUMMARY

Embodiments are directed to a negative active material for a rechargeable lithium battery and a rechargeable lithium battery including the same.

At least one of the above and other features and advantages may be realized by providing a negative active material for a rechargeable lithium battery, the negative active material including a metal-based active material; and a solid electrolyte having an ion conductivity of about 1.0×10⁻⁴ S/cm or greater.

The solid electrolyte may have an ion conductivity of about 1.0×10⁻⁴ S/cm to about 4.0×10⁻³ S/cm.

The solid electrolyte may include at least one represented by the following Chemical Formulae 1 to 5:

LiₐX_{b}Y_{c}Z_{d}Oₑ [Chemical Formula 1]

wherein, in Chemical Formula 1,

X may be Zn, Sr, La, Pr, Nd, Eu, Sm, Ta, Ba, Ca, or a combination thereof,

Y may be Sr, Sb, Nb, Ti, Al, Mg, La, F, Si, B, Ge, O, or a combination thereof

Z may be In, Mg, W, Al, V, P, Si, or a combination thereof, and

a may be from 0.1 to 6.0, b may be from 0 to 3.0, c may be from 0 to 3.0, d may be from 0 to 3.0, and e may be from 0 to 5.0;

LiₐX_{b}Y_{c}Z_{d}(PO₄)ₑ [Chemical Formula 2]

wherein, in Chemical Formula 2,

X may be Zn, Sr, La, Pr, Nd, Eu, Sm, Ta, Ba, Ca, or a combination thereof,

Y may be Sr, Sb, Nb, Ti, Al, Mg, La, F, Si, B, Ge, O, or a combination thereof.

Z may be In, Mg, W, Al, V, P, Si, or a combination thereof, and

a may be from 0.1 to 6.0, b may be from 0 to 3.0, c may be from 0 to 3.0, d may be from 0 to 3.0, and e may be from 0 to 5.0;

LiₐX_{b}Y_{c}Z_{d}Sₑ [Chemical Formula 3]

wherein, in Chemical Formula 3,

X may be P, Ge, Si, As, or a combination thereof,

Y may be O, P, Ga, or a combination thereof,

Z may be In, Mg, W, Al, V, P, Si, or a combination thereof, and

a may be from 0.1 to 6.0, b may be from 0 to 3.0, c may be from 0 to 3.0, d may be from 0 to 3.0, and e may be from 0 to 5.0;

LiₐX_{b}Y_{c} [Chemical Formula 4]

wherein, in Chemical Formula 4,

X may be N, β-Al₂O₃, Cd, I, P, or a combination thereof,

Y may be Cl, Br, N, or a combination thereof, and

a may be from 0.1 to 6.0, b may be from 0 to 3.0, and c may be from 0 to 3.0; and

NₐX_{b}Y_{c}Z_{d}Oₑ [Chemical Formula 5]

wherein, in Chemical Formula 5,

X may be Zn, Sr, La, Pr, Nd, Eu, Sm, Ta, Ba, Ca, or a combination thereof,

Y may be Sr, Sb, Nb, Ti, Al, Mg, La, F, Si, B, Ge, O, or a combination thereof,

Z may be In, Mg, W, Al, V, P, Si, or a combination thereof, and

a may be from 0.1 to 6.0, b may be from 0 to 3.0, c may be from 0 to 3.0, d may be from 0 to 3.0, and e may be from 0 to 5.0.

The negative metal-based active material may include Si, a Si-Q alloy in which Q is an element including an alkali metal, an alkaline-earth metal, a Group 13 element, a Group 13 element, a transition element, a rare earth element, or a combination thereof, and is not Si, Sn, Sn—R in which R is an element including an alkali metal, an alkaline-earth metal, a Group 13 element, a Group 13 element, a transition element, a rare earth element, or a combination thereof, and is not Sn, or a combination thereof.

The solid electrolyte may be mixed with the metal-based active material.

A surface of the metal-based active material may be coated with the solid electrolyte.

The metal-based active material may have an average particle size of about 100 nm to about 15 μm.

The solid electrolyte may have an average particle size of about 100 nm to about 500 nm.

A mixing ratio of the metal-based active material to the solid electrolyte may be about 99.99:0.01 wt % to about 70:30 wt %.

At least one of the above and other features and advantages may also be realized by providing a rechargeable lithium battery including a negative electrode including a negative active material; a positive electrode including a positive active material; and a non-aqueous electrolyte, wherein the negative active material includes a metal-based active material and a solid electrolyte, the solid electrolyte having an ion conductivity of about 1.0×10⁻⁴S/cm or greater.

The solid electrolyte may have an ion conductivity of about 1.0×10⁻⁴ S/cm to about 4.0×10⁻³ S/cm.

The solid electrolyte may include at least one represented by the following Chemical Formulae 1 to 5:

LiₐX_{b}Y_{c}Z_{d}Oₑ [Chemical Formula 1]

wherein, in Chemical Formula 1,

X may be Zn, Sr, La, Pr, Nd, Eu, Sm, Ta, Ba, Ca, or a combination thereof,

Y may be Sr, Sb, Nb, Ti, Al, Mg, La, F, Si, B, Ge, O, or a combination thereof

Z may be In, Mg, W, Al, V, P, Si, or a combination thereof, and

a may be from 0.1 to 6.0, b may be from 0 to 3.0, c may be from 0 to 3.0, d may be from 0 to 3.0, and e may be from 0 to 5.0;

LiₐX_{b}Y_{c}Z_{d}(PO₄)ₑ [Chemical Formula 2]

wherein, in Chemical Formula 2,

X may be Zn, Sr, La, Pr, Nd, Eu, Sm, Ta, Ba, Ca, or a combination thereof,

Y may be Sr, Sb, Nb, Ti, Al, Mg, La, F, Si, B, Ge, O, or a combination thereof

Z may be In, Mg, W, Al, V, P, Si, or a combination thereof, and

a may be from 0.1 to 6.0, b may be from 0 to 3.0, c may be from 0 to 3.0, d may be from 0 to 3.0, and e may be from 0 to 5.0;

LiₐX_{b}Y_{c}ZₐSₑ [Chemical Formula 3]

wherein, in Chemical Formula 3,

X may be P, Ge, Si, As, or a combination thereof,

Y may be O, P, Ga, or a combination thereof,

Z may be In, Mg, W, Al, V, P, Si, or a combination thereof, and

a may be from 0.1 to 6.0, b may be from 0 to 3.0, c may be from 0 to 3.0, d may be from 0 to 3.0, and e may be from 0 to 5.0;

LiₐX_{b}Y_{c} [Chemical Formula 4]

wherein, in Chemical Formula 4,

X may be N, β-Al₂O₃, Cd, I, P, or a combination thereof,

Y may be Cl, Br, N, or a combination thereof, and

a may be from 0.1 to 6.0, b may be from 0 to 3.0, and c may be from 0 to 3.0; and

NₐX_{b}Y_{c}Z_{d}Oₑ [Chemical Formula 5]

wherein, in Chemical Formula 5,

X may be Zn, Sr, La, Pr, Nd, Eu, Sm, Ta, Ba, Ca, or a combination thereof,

Y may be Sr, Sb, Nb, Ti, Al, Mg, La, F, Si, B, Ge, O, or a combination thereof,

Z may be In, Mg, W, Al, V, P, Si, or a combination thereof, and

a may be from 0.1 to 6.0, b may be from 0 to 3.0, c may be from 0 to 3.0, d may be from 0 to 3.0, and e may be from 0 to 5.0.

The negative metal-based active material may include Si, a Si-Q alloy in which Q is an element including an alkali metal, an alkaline-earth metal, a Group 13 element, a Group 13 element, a transition element, a rare earth element, or a combination thereof, and is not Si, Sn, Sn—R in which R is an element including an alkali metal, an alkaline-earth metal, a Group 13 element, a Group 13 element, a transition element, a rare earth element, or a combination thereof, and is not Sn, or a combination thereof.

The solid electrolyte may be mixed with the metal-based active material.

A surface of the metal-based active material may be coated with the solid electrolyte.

The metal-based active material may have an average particle size of about 100 nm to about 15 μm.

The solid electrolyte may have an average particle size of about 100 nm to about 500 nm.

A mixing ratio of the metal-based active material to the solid electrolyte may be about 99.99:0.01 wt % to about 70:30 wt %.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic diagram showing charge/discharge status of a negative electrode including a metal-based active material;

FIG. 2 illustrates a schematic diagram showing charge/discharge status of a negative electrode including a metal-based active material and a solid electrolyte according to an embodiment;

FIG. 3 schematically illustrates a structure of a rechargeable lithium battery according to an embodiment;

FIG. 4 illustrates a graph showing XRD of a solid electrolyte prepared according to Example 1;

FIG. 5 illustrates a graph showing a life-cycle characteristic of a half-cell manufactured using negative active materials of Examples 1 and 2 and Comparative Examples 1 and 2.

### DETAILED DESCRIPTION

Korean Patent Application No. 10-2010-0064942, filed on Jul. 6, 2010, in the Korean Intellectual Property Office, and entitled: “Negative Active Material for Rechargeable Lithium Battery and Rechargeable Lithium Battery Including Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

An embodiment provides a negative active material for a rechargeable lithium battery that includes a metal-based active material and a solid electrolyte having an ion conductivity of about 1.0×10⁻⁴ S/cm or greater.

The metal-based active material may include, e.g., Si, a Si-Q alloy (where Q is an element including an alkali metal, an alkaline-earth metal, a Group 13 element, a Group 13 element, a transition element, a rare earth element, or a combination thereof, and is not Si), Sn, Sn—R (where R is an element including an alkali metal, an alkaline-earth metal, a Group 13 element, a Group 13 element, a transition element, a rare earth element, or a combination thereof, and is not Sn), or a combination thereof.

The metal-based active material may exist as a particle; and an average particle size thereof may be about 100 nm to about 15 μm. Maintaining the particle size of the metal-based active material at about 100 nm to about 15 μm may facilitate economical and easy acquisition and may also have an excellent output characteristic.

The solid electrolyte may be mixed with the metal-based active material or may be a coating layer on a surface of the metal-based active material. Regardless of a state of the solid electrolyte, when the solid electrolyte exists around the metal-based active material, e.g., mixed or coated, volume expansion, formation of dendrites, and non-reversible reaction occurring when the metal-based active material is charged/discharged may be reduced. As a result, life-cycle characteristic may be improved. If an active material layer of the metal-based active material is formed in or on a current collector and the solid electrolyte exists as an independent layer on the active material layer, the solid electrolyte may not exist around the metal-based active material over the active material layer. Thus, effects of suppressing formation of dendrites by contributing to ion diffusion inside the metal-based active material, volume expansion occurring during charge/discharge, and effects of reducing a non-reversible reaction may be insignificant.

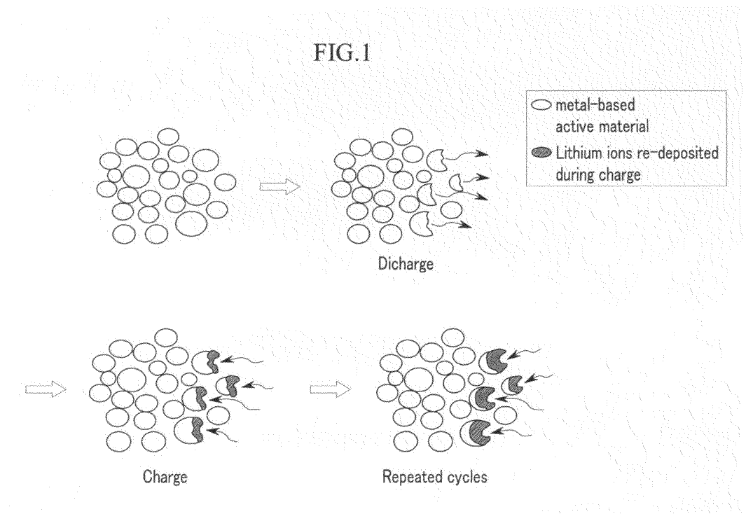

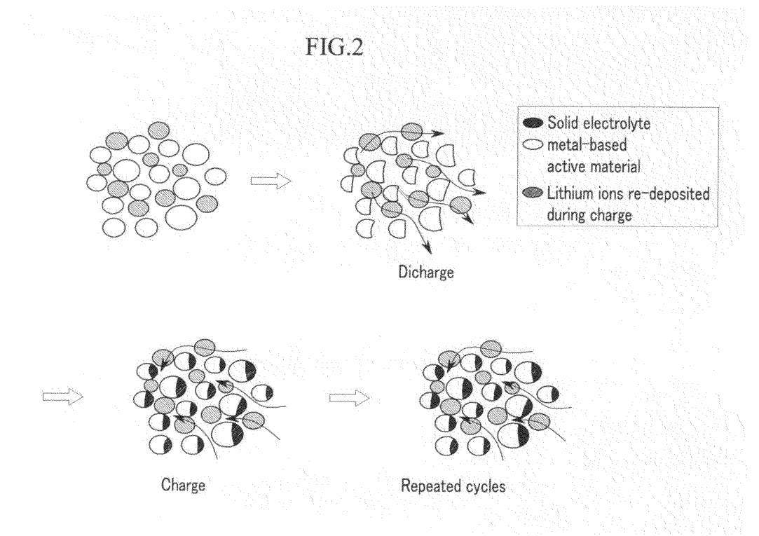

This will be described hereafter in detail with reference to FIGS. 1 and 2.

FIG. 1 illustrates a schematic view of formation of dendrites when a negative electrode including a metal-based active material is charged/discharged repeatedly. As shown in FIG. 1, as a re-deposition phenomenon of lithium ions occurring during a charge may occur locally on a specific region of a metal-based active material, dendrites may be formed and volume may be increased. Also, due to formation of dendrites and volume expansion, cracks may occur and the surface area may be increased, and a non-reversible reaction with an electrolyte solution may be increased.

As shown in FIG. 2, a solid electrolyte may exist around a metal-based active material. Thus, the re-deposition phenomenon of lithium ions may uniformly occur on the metal-based active material. Accordingly, the formation of dendrites and the volume expansion may occur to a lesser degree, cracks may be prevented, and there may be no increase in surface area. Therefore, the non-reversible reaction with the electrolyte solution may also decrease.

The solid electrolyte may have an ion conductivity of about 1.0×10⁻⁴ S/cm or greater. In an implementation, the solid electrolyte may have an ion conductivity of about 1.0×10⁻⁴ S/cm to about 4.0×10⁻³ S/cm. Maintaining the ion conductivity at about 1.0×10⁻⁴ S/cm or greater may help ensure that beneficial effects of using the solid electrolyte are achieved. In other words, when the solid electrolyte is used along with the metal-based active material and the solid electrolyte has the ion conductivity of about 1.0×10⁻⁴ S/cm or greater, the volume expansion, formation of dendrites, and the non-reversible reaction that may occur when the metal-based active material is charged/discharged may be prevented. As a result, the life-cycle characteristic may be improved. For example, polyethylene oxide should not be used because the ion conductivity thereof is too low, i.e., less than about 1.0×10⁻⁴ S/cm.

The ion conductivity may be measured by using electrochemical impedance spectroscopy (EIS), pressing the solid electrolyte in the form of pellet, positioning Pt electrodes on both sides of the pellet, and measuring impedance.

The solid electrolyte may include a compound represented by at least one of the following Chemical Formulae 1 to 5.

LiₐX_{b}Y_{c}Z_{d}Oₑ [Chemical Formula 1]

In Chemical Formula 1,

X may include, e.g., Zn, Sr, La, Pr, Nd, Eu, Sm, Ta, Ba, Ca, or a combination thereof,

Y may include, e.g., Sr, Sb, Nb, Ti, Al, Mg, La, F, Si, B, Ge, O, or a combination thereof,

Z may include, e.g., In, Mg, W, Al, V, P, Si, or a combination thereof, and

a may be from 0.1 to 6.0, b may be from 0 to 3.0, c may be from 0 to 3.0, d may be from 0 to 3.0, and e may be from 0 to 5.0.

LiₐX_{b}Y_{c}Z_{d}(PO₄)ₑ [Chemical Formula 2]

In Chemical Formula 2,

X may include, e.g., Zn, Sr, La, Pr, Nd, Eu, Sm, Ta, Ba, Ca, or a combination thereof,

Y may include, e.g., Sr, Sb, Nb, Ti, Al, Mg, La, F, Si, B, Ge, O, or a combination thereof,

Z may include, e.g., In, Mg, W, Al, V, P, Si, or a combination thereof, and

a may be from 0.1 to 6.0, b may be from 0 to 3.0, c may be from 0 to 3.0, d may be from 0 to 3.0, and e may be from 0 to 5.0.

LiₐX_{b}Y_{c}Z_{d}Sₑ [Chemical Formula 3]

In Chemical Formula 3,

X may include, e.g., P, Ge, Si, As, or a combination thereof,

Y may include, e.g., O, P, Ga, or a combination thereof,

Z may include, e.g., In, Mg, W, Al, V, P, Si, or a combination thereof, and

a may be from 0.1 to 6.0, b may be from 0 to 3.0, c may be from 0 to 3.0, d may be from 0 to 3.0, and e may be from 0 to 5.0.

LiₐX_{b}Y_{c} [Chemical Formula 4]

In Chemical Formula 4,

X may include, e.g., N, β-Al₂O₃, Cd, I, P or combination thereof,

Y may include, e.g., Cl, Br, N, or a combination thereof, and

a may be from 0.1 to 6.0, b may be from 0 to 3.0, c may be from 0 to 3.0, d may be from 0 to 3.0, and e may be from 0 to 5.0.

NₐX_{b}Y_{c}Z_{d}Oₑ [Chemical Formula 5]

In Chemical Formula 5,

X may include, e.g., Zn, Sr, La, Pr, Nd, Eu, Sm, Ta, Ba, Ca, or a combination thereof,

Y may include, e.g., Sr, Sb, Nb, Ti, Al, Mg, La, F, Si, B, Ge, O, or a combination thereof,

Z may include, e.g., In, Mg, W, Al, V, P, Si, or a combination thereof, and

a may be from 0.1 to 6.0, b may be from 0 to 3.0, c may be from 0 to 3.0, d may be from 0 to 3.0, and e may be from 0 to 5.0.

The solid electrolyte may have an average particle size of about 100 nm to about 500 nm. Maintaining the particle size of the solid electrolyte at about 100 nm to about 500 nm may help ensure that the solid electrolyte particle does not agglomerate, is easily applied for coating, and maintains proper ion conductivity.

The solid electrolyte having excellent ion conductivity may be used for a negative electrode. Thus, lithium ions may be well diffused. As a result, the undesirable dendrite phenomenon occurring as lithium ions are non-uniformly deposited on the negative active material may be suppressed. Thus, the life-cycle characteristic may be improved.

A mixing ratio of the metal-based active material to the solid electrolyte may be about 99.99:0.01 wt % to about 70:30 wt %. Maintaining the content of the solid electrolyte relative to the metal-based active material within these amounts may help ensure that an initial capacity is significantly increased and that there is an excellent effect in that the initial capacity may be more than doubled compared to when a crystalline negative active material, e.g., graphite, is used, and the life-cycle characteristic may be further improved.

As described above, the negative active material may exist in a state in which the solid electrolyte is mixed with the metal-based active material or as a coating layer on the surface of the metal-based active material. When the negative active material exists in a state in which the solid electrolyte is mixed with the metal-based active material, it may be prepared by physically drying or mixing the solid electrolyte and the metal-based active material. When the negative active material exists as a coating layer, it may be prepared by adding the solid electrolyte to a solvent so as to prepare a coating liquid and then coating a surface of the metal-based active material with the coating liquid. The coating method may include any suitable coating method, e.g., spray coating and an immersion method. The solvent may include, e.g., ethanol, ethanol anhydride, and/or isopropyl alcohol. A concentration of the coating liquid may be about 10 wt % to about 40 wt %; and a thickness of the coating layer may be about 100 nm to about 5 μm.

Another embodiment provides a rechargeable lithium battery.

Rechargeable lithium batteries may be classified into, e.g., lithium ion batteries, lithium ion polymer batteries, and lithium polymer batteries, according to presence of a separator and a kind of electrolyte used in the rechargeable battery. The rechargeable lithium batteries may have a variety of shapes and sizes, e.g., cylindrical, prismatic, or coin-type batteries, and may include thin film batteries or may be rather bulky in size. Structures and fabrication methods for lithium ion batteries are well known in the art.

The rechargeable lithium battery may include a negative electrode including a negative active material according to an embodiment, a positive electrode including a positive active material, and a non-aqueous electrolyte.

The negative electrode may include a negative active material layer including the negative active material of an embodiment and the current collector.

The negative active material layer may include about 95 to about 99 wt % of the negative active material, based on a total weight of the negative active material layer.

The negative active material layer may also include a binder and may further include a conductive material. The negative active material layer may include about 1 to about 5 wt % of the binder, based on a total weight of the negative active material in the negative active material layer. When the negative active material layer further includes a conductive material, about 90 to about 98 wt % of the negative active material, about 1 to about 5 wt % of the binder, and about 1 to about 5 wt % of the conductive material may be included.

The binder may improve binding properties of the negative active material particles to one another and to a current collector. The binder may include, e.g., a non-water-soluble binder, a water-soluble binder, or a combination thereof.

The non-water-soluble binder may include, e.g., polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The water-soluble binder may include, e.g., a styrene-butadiene rubber, an acrylated styrene-butadiene rubber, polyvinyl alcohol, sodium polyacrylate, a copolymer including repeating units derived from propylene and a C2 to C8 olefin, a copolymer of (meth)acrylic acid and (meth)acrylic acid alkyl ester, or a combination thereof.

When the water-soluble binder is used as a negative electrode binder, a cellulose-based compound may be further used to provide viscosity. The cellulose-based compound may include one or more of, e.g., carboxylmethyl cellulose, hydroxypropylmethyl cellulose, methyl cellulose, or alkaline metal salts thereof. The alkaline metal may include, e.g., Na, K, or Li. The cellulose-based compound may be included in an amount of about 0.1 to about 3 parts by weight, based on 100 parts by weight of the binder.

The conductive material may include any suitable electro-conductive material that does not cause a chemical change. The conductive material may include, e.g., a carbon-based material such as natural graphite, artificial graphite, carbon black, acetylene black, ketjen black, and carbon fiber; a metal-based material such as a metal powder or a metal fiber including copper, nickel, aluminum, and silver; a conductive polymer such as a polyphenylene derivative; and a mixture thereof.

As described above, the negative electrode may include the current collector. The current collector may include, e.g., a copper foil, a nickel foil, a stainless steel foil, a titanium foil, a nickel foam, a copper foam, a polymer substrate coated with a conductive metal, or combinations thereof.

The positive electrode may include a current collector and a positive active material layer disposed on the current collector. The positive active material may include, e.g., lithiated intercalation compounds that reversibly intercalate and deintercalate lithium ions. The positive active material may include a composite oxide including at least one of, e.g., cobalt, manganese, and nickel, as well as lithium. For example, the following lithium-containing compounds may be used. LiₐA_{1-b}X_{b}D₂(0.90≦a≦1.8 and 0≦b≦0.5); LiₐE_{1-b}X_{b}X_{2-c}D_{c}(0.90≦a≦1.8, 0≦b≦0.5, and 0≦c≦0.05); LiₐE_{2-b}X_{b}O_{4-c}D_{c} (0≦a≦1.8, 0≦b≦0.5, and 0≦c≦0.05); LiₐNi_{1-b-c}Co_{b}X_{c}D_{α}(0.90≦a≦1.8, 0≦b≦0.5, 0≦c≦0.05, and 0<α<2); LiₐNi_{1-b-c}Co_{b}X_{c}O_{2-α}T_{α}(0.90≦a≦1.8, 0≦b≦0.5, 0≦c≦0.05, and 0<α<2); LiₐNi_{1-b-c}Co_{b}X_{c}O_{2-α}T₂(0.90≦a≦1.8, 0≦b≦0.5, 0≦c≦0.05, and 0<α<2); LiₐNi_{1-b-c}Mn_{b}X_{c}D_{α}(0.90≦a≦1.8, 0≦b≦0.5, 0≦c≦0.05, and 0<α<2); LiₐNi_{1-b-c}Mn_{b}X_{c}O_{2-α}T_{α}(0.90≦a≦1.8, 0≦b≦0.5, 0≦c≦0.05, and 0<α<2); LiₐNi_{1-b-c}Mn_{b}X_{c}O_{2-α}T₂(0.90≦a≦1.8, 0≦b≦0.5, 0≦c≦0.05, and 0<α<2); LiₐNi_{b}E_{c}G_{d}O₂ (0.90≦a≦1.8, 0≦b≦0.9, 0≦c≦0.5, and 0.001≦d≦0.1); LiₐNi_{b}Co_{c}Mn_{d}GₑO₂(0.90≦a≦1.8, 0≦b≦0.9, 0≦c≦0.5, 0≦d≦0.5, and 0.001≦e≦0.1); LiₐNiG_{b}O₂(0.90≦a≦1.8 and 0.001≦b≦0.1) LiₐCoG_{b}O₂(0.90≦a≦1.8 and 0.001≦b≦0.1); LiₐMnG_{b}O₂ (0.90≦a≦1.8 and 0.001≦b≦0.1); LiₐMn₂G_{b}O₄ (0.90≦a≦1.8 and 0.001≦b≦0.1); QO₂; QS₂; LiQS₂; V₂O₅; LiV₂O₅; LiZO₂; LiNiVO₄; Li_{(3-f)}J₂(PO₄)₃(0≦f≦2); Li_{(3-f)}Fe₂(PO₄)₃(0≦f≦2); and LiFePO₄.

In the above formulae, A may include, e.g., Ni, Co, Mn, and a combination thereof; X may include, e.g., Al, Ni, Co, Mn, Cr, Fe, Mg, Sr, V, a rare earth element, or a combination thereof; D may include, e.g., O, F, S, P, and a combination thereof; E may include, e.g., Co, Mn, and a combination thereof; T may include, e.g., F, S, P, or a combination thereof; G may include, e.g., Al, Cr, Mn, Fe, Mg, La, Ce, Sr, V, or a combination thereof; Q may include, e.g., Ti, Mo, Mn, or a combination thereof; Z may include, e.g., Cr, V, Fe, Sc, Y, or a combination thereof; and J may include, e.g., V, Cr, Mn, Co, Ni, Cu, or a combination thereof.

The compound may have a coating layer on a surface thereof or may be mixed with another compound having a coating layer. The coating layer may include at least one coating element compound including, e.g., an oxide of a coating element, a hydroxide, an oxyhydroxide of a coating element, an oxycarbonate of a coating element, and/or a hydroxyl carbonate of a coating element. The compound for a coating layer may be amorphous or crystalline. The coating element included in the coating layer may include, e.g., Mg, Al, Co, K, Na, Ca, Si, Ti, V, Sn, Ge, Ga, B, As, Zr, or a mixture thereof. The coating layer may be formed using a method having no adverse influence on properties of a positive active material by including these elements in the compound. For example, the method may include any suitable coating method such as spray coating, dipping, and the like, but is not illustrated in more detail, since it is well-known to those who work in the related field.

In the positive active material layer, the positive active material may be included in an amount of about 90 to about 98 wt %, based on a total weight of the positive active material layer.

The positive active material layer may also include a binder and a conductive material. The binder and conductive material may each be included in an amount of about 1 to about 5 wt %, based on a total weight of the positive active material layer.

The binder may improve binding properties of positive active material particles among one another and with the current collector. The binder may include, e.g., polyvinyl alcohol, carboxylmethyl cellulose, hydroxypropyl cellulose, diacetyl cellulose, polyvinyl chloride, carboxylated polyvinyl chloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like, but is not limited thereto.

The conductive material may improve electrode conductivity. Any suitable electrically conductive material that does not cause a chemical change may be used as the conductive material. In an implementation, the conductive material may include, e.g., a carbon-based material such as natural graphite, artificial graphite, carbon black, acetylene black, ketjen black, carbon fiber, and the like; a metal-based material such as a metal powder or a metal fiber including copper, nickel, aluminum, silver and the like; a conductive polymer such as a polyphenylene derivative; and/or a mixture thereof.

The current collector may include, e.g., Al, but is not limited thereto.

The negative and positive electrodes may be fabricated by a method including, e.g., mixing the active material, conductive material, and binder into an active material composition and coating the composition on a current collector. The electrode manufacturing method is well known, and thus is not described in detail here. The solvent may include, e.g., N-methylpyrrolidone and the like, but is not limited thereto. When a water-soluble binder is used in a negative electrode, water may be used as a solvent for preparing a negative active material composition.

The non-aqueous electrolyte may include, e.g., a non-aqueous organic solvent and a lithium salt.

The non-aqueous organic solvent may serve as a medium for transmitting ions taking part in the electrochemical reaction of the battery.

The non-aqueous organic solvent may include, e.g., a carbonate-based, an ester-based, an ether-based, a ketone-based, an alcohol-based, or an aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and the like. Examples of the ether-based solvent may include dibutyl ether, tetraglyme, diglyme, dimethoxyethane, 2-methyltetrahydrofuran, tetrahydrofuran, and the like, and examples of the ketone-based solvent may include cyclohexanone and the like. Examples of the alcohol-based solvent may include ethyl alcohol, isopropyl alcohol, and the like, and examples of the aprotic solvent may include nitriles such as R—CN (where R is a C2 to C20 linear, branched, or cyclic hydrocarbon, a double bond, an aromatic ring, or an ether bond), amides such as dimethylformamide, dioxolanes such as 1,3-dioxolane, sulfolanes, and the like.

The non-aqueous organic solvent may be used singularly or in a mixture thereof. When the organic solvent is used in a mixture, a mixture ratio may be controlled in accordance with a desired battery performance.

The carbonate-based solvent may include a mixture of a cyclic carbonate and a chain carbonate. The cyclic carbonate and the chain carbonate may be mixed together in a volume ratio of about 1:1 to about 1:9. When the mixture is used as an electrolyte, electrolyte performance may be enhanced.

In addition, the non-aqueous organic electrolyte may further include mixtures of carbonate-based solvents and aromatic hydrocarbon-based solvents. The carbonate-based solvents and the aromatic hydrocarbon-based solvents may be mixed together in a volume ratio of about 1:1 to about 30:1.

The aromatic hydrocarbon-based organic solvent may be represented by the following Chemical Formula 6.

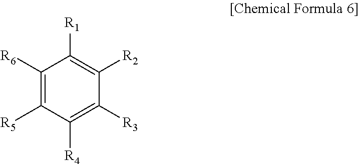

In Chemical Formula 6, R₁ to R₆ may each independently be, e.g., hydrogen, a halogen, a C1 to C10 alkyl, a C1 to C10 haloalkyl, or a combination thereof.

The aromatic hydrocarbon-based organic solvent may include at least one of, e.g., benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The non-aqueous electrolyte may further include an additive including a vinylene carbonate or an ethylene carbonate-based compound represented by the following Chemical Formula 7.

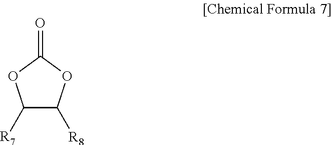

In Chemical Formula 7, R₇ and R₈ may each independently be hydrogen, a halogen, a cyano (CN), a nitro (NO₂), and a C1 to C5 fluoroalkyl, provided that at least one of R₇ and R₈ is a halogen, a nitro (NO₂), or a C1 to C5 fluoroalkyl, and R₇ and R₈ are not simultaneously hydrogen.

Examples of the ethylene carbonate-based compound may include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like. An amount of additive for improving life-cycle characteristic may be adjusted within an appropriate range.

The lithium salt may supply lithium ions in the battery, may operate a basic operation of a rechargeable lithium battery, and may improve lithium ion transportation between positive and negative electrodes. The lithium salt may include, e.g., at least one supporting salt including LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, and LiB(C₂O₄)₂ (lithium bisoxalato borate, LiBOB). The lithium salt may be used in a concentration of about 0.1 M to about 2.0 M. Maintaining the concentration of the lithium salt at about 0.1 M to about 2.0 M may help ensure that electrolyte performance and lithium ion mobility are enhanced due to optimal electrolyte conductivity and viscosity.

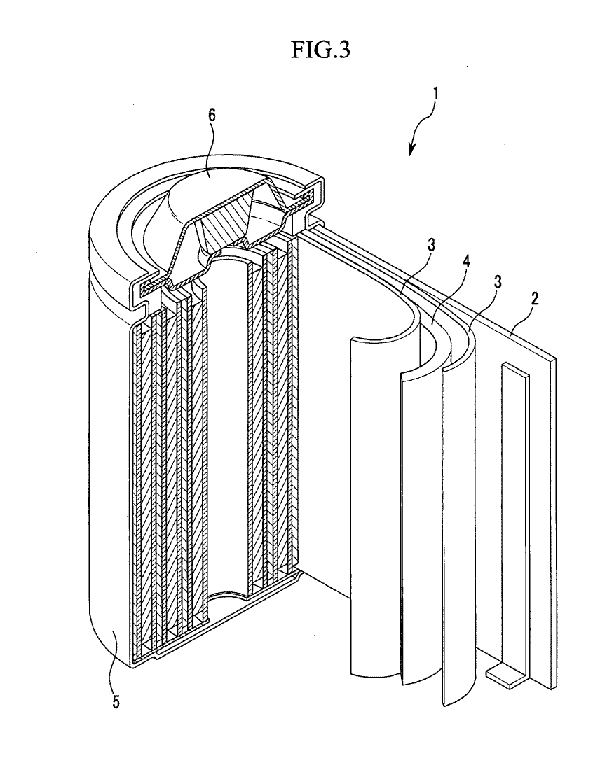

FIG. 3 illustrates a schematic view of a representative structure of a rechargeable lithium battery according to an embodiment. As shown in FIG. 3, the rechargeable lithium battery 1 may include a battery case 5 containing a positive electrode 4, a negative electrode 2, and a separator 3 interposed between the positive electrode 4 and the negative electrode 2, an electrolyte solution (not illustrated) impregnated therein, and a sealing member 6 sealing the battery case 5.

As described above, the rechargeable lithium battery may include the separator 3 between the negative electrode 2 and the positive electrode 4. Non-limiting examples of suitable separator materials include polyethylene, polypropylene, polyvinylidene fluoride, and/or multi-layers thereof such as a polyethylene/polypropylene double-layered separator, a polyethylene/polypropylene/polyethylene triple-layered separator, and a polypropylene/polyethylene/polypropylene triple-layered separator.

The following examples illustrate the embodiments in more detail. These examples, however, are not in any sense to be interpreted as limiting the scope of this disclosure.

### Example 1

### 1) Preparation of Solid Electrolyte

Li₂CO₃, Al₂O₃, TiO₂, and (NH₄)₂HPO₄ were agitated in an ethanol solvent at a speed of about 120 rpm for about 2 hours. Herein, a mixing ratio of Li₂CO₃, Al₂O₃, TiO₂, and (NH₄)₂HPO₄ was about 1.8791:0.5984:5.3118:15.4992 by weight.

The mixture was calcinated at about 700° C. for about 2 hours, and a calcination product acquired from the calcination was primarily agitated in an ethanol solvent at a speed of about 120 rpm for about 6 hours and secondarily agitated at a speed of about 50 rpm for about 6 hours.

An agitation product acquired from the agitation was dried in under ambient atmosphere at a temperature of about 120° C. for about 3 hours, and sintered in the ambient atmosphere at a temperature of about 920° C. for about 8 hours.

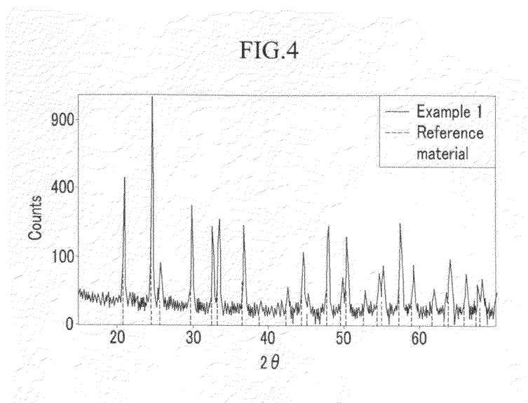

A sintering product acquired from the sintering process was pressed under a pressure of about 4.5 tons, and a product acquired from the pressing was sintered under ambient atmosphere at a temperature of about 1000° C. for about 2 hours to prepare a Li_{1.3}Ti_{1.7}Al_{0.3}(PO₄)₃ solid electrolyte. X-ray diffraction of the prepared Li_{1.3}Ti_{1.7}Al_{0.3}(PO₄)₃ solid electrolyte was measured using CuKα, and the measurement result showed that the prepared Li_{1.3}Ti_{1.7}Al_{0.3}(PO₄)₃ solid electrolyte had a similar structure to a LiTi₂(PO₄)₃ reference material, as shown in FIG. 4. It was found that owing to the small of amount of Al, the prepared Li_{1.3}Ti_{1.7}Al_{0.3}(PO₄)₃ solid electrolyte peak appeared to be slightly shifted, compared to the position of the LiTi₂(PO₄)₃, and a main or core structure was similar to that of the LiTi₂(PO₄)₃.

Also, when the prepared Li_{1.3}Ti_{1.7}Al_{0.3}(PO₄)₃ solid electrolyte was prepared in the form of a pellet, Pt electrodes were positioned on both sides of the pellet, and the ion conductivity was measured with EIS, which was used for measuring impedance, the ion conductivity was about 1.19×10⁻⁴S/cm.

### 2) Fabrication of Electrode

A negative active material was prepared by dry-mixing about 80 wt % of Sn powder (produced by Aldrich Company and having an average particle size of less than about 10 μm and particle purity of about 99% or higher) with about 20 wt % of the prepared solid electrolyte described above.

A negative active material slurry was prepared by mixing the negative active material, a super-P conductive material, and a polyvinylidene fluoride binder in an N-methylpyrrolidone solvent at a ratio of about 94:3:3 wt %.

A negative electrode having an average thickness of about 60 μm and a negative electrode active mass loading level of about 10 mg/cm² was fabricated by coating a copper current collector having a thickness of about 10 μm with the negative active material slurry, drying the copper current collector coated with the negative active material slurry, and pressing it.

### Example 2

A negative active material was prepared by dry-mixing about 90 wt % of Sn powder (produced by Aldrich Company and having an average particle size of less than about 10 μm and particle purity of about 99% or higher) with about 10 wt % of the solid electrolyte used in Example 1.

A negative electrode was fabricated using the negative active material according to the same method as Example 1.

### Comparative Example 1

A negative active material slurry was prepared by mixing Sn powder (produced by Aldrich Company and having an average particle size of less than about 10 μm and particle purity of about 99 wt %) negative active material, a super-P conductive material, and a polyvinylidene fluoride binder in an N-methylpyrrolidone solvent at a ratio of about 94:3:3 wt %.

A negative electrode was prepared by coating a copper current collector having a thickness of about 10 μm and a negative electrode active mass loading level of about 10 mg/cm² with the negative active material slurry, drying the copper current collector coated with the negative active material slurry, and rolling it.

### Comparative Example 2

A negative active material slurry was prepared by dry-mixing about 90 wt % of Sn powder (produced by Aldrich Company, having an average particle size of less than about 10 μm, and a particle purity of about 99 wt % or higher) with about 10 wt % of a LiTi₂(PO₄)₃ solid electrolyte having ion conductivity of 1.50×10⁻⁵S/cm. The ion conductivity of the LiTi₂(PO₄)₃ solid electrolyte was measured by preparing the solid electrolyte in the form of a pellet, positioning Pt electrodes on both sides of the pellet, and using EIS, which is an instrument for measuring impedance.

A negative electrode was fabricated using the negative active material and performing the same method as Example 1.

Analysis

Coin-type half-cells were manufactured by using the negative electrodes fabricated according to Examples 1 and 2 and Comparative Examples 1 and 2 and using a lithium metal as a counter electrode. Herein, the electrolyte solution was a 1.15 M LiPF₆ solution in a mixed solvent of ethylene carbonate, ethylmethyl carbonate, and diethyl carbonate (3:3:4 volume ratio).

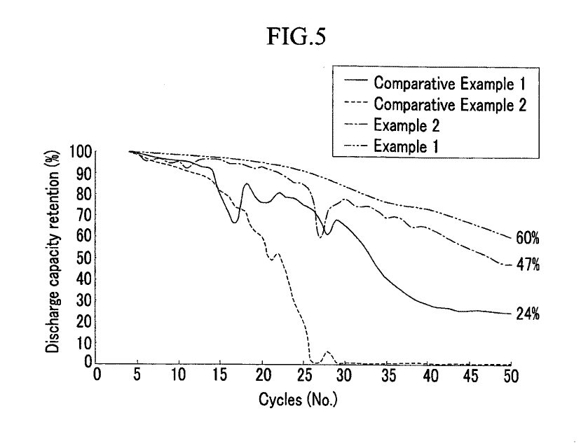

The manufactured half-cells were charged/discharged 50 times with a 0.1 C constant current charge (cut-off voltage: 0.01 V) and a 0.1 C constant current discharge (cut-off voltage: 1.5 V), and their discharge capacity retentions based on the cycle number are as shown in FIG. 5. As shown in FIG. 5, in the case of Comparative Example 1 that did not use a solid electrolyte, the life-cycle characteristic evaluation showed that the discharge capacity retention was deteriorated to lower than about 80% after about 15 cycles, after about 30 cycles it was deteriorated lower than about 60%, and after about 60 cycles it was remarkably deteriorated to about 24%. On the other hand, in the case of Examples 1 and 2 using Sn and a solid electrolyte, respectively, they had capacity retentions of about 60% and about 47% even after about 50 cycles.

Also, although a solid electrolyte was used for the half-cell of Comparative Example 2, which used a solid electrolyte having low ion conductivity of about 1.50×10⁻⁵S/cm, the discharge capacity retention was drastically deteriorated after about 20 cycles, and little discharge capacity was acquired after about 30 cycles.

Graphite-based active materials may have a theoretical lithium occlusion capacity of about 372 mAh/g, which may account for about 10% of a theoretical lithium metal capacity, which is very small. Therefore, as high capacity is desired, researchers are actively studying lithium metal and metal alloys as negative active materials.

In lithium metal and metal alloy negative active materials, dendrites may be formed during a recharge process. In addition, dendrites formed as charge and discharge processes are repeated may penetrate through a separator and cause an internal short-circuit. Also, due to the formation of the dendrites, a specific surface area of the negative electrode may be increased and thus, reactivity may be drastically increased. As a result, a non-reversible reaction between the lithium metal and an electrolyte may actively occur and thus, life-cycle characteristic may be drastically deteriorated.

A structural method of minimizing growth of the dendrites by coating a surface of the lithium metal negative active material or using a lithium metal powder, which may be prepared by coating lithium metal with a carbon or polymer, has been suggested.

Yet another method is to minimize education of lithium metal by using a lithium alloy or a metal material, e.g., Sn or Si. When such a structure and the metal alloy or a compound are formed and calculated in terms of electrochemical capacities, their theoretical capacities may be about 3862 mAh/g for Li, about 4200 mAh/g for Si, and about 994 mAh/g for Sn. When electrochemical reversibility is secured, superb discharge capacity may be secured, compared with graphite-based negative active materials.

However, the metal-based active material may still exhibit drastic deterioration of, e.g., electrochemical reversibility, charge and discharge efficiency according to the electrochemical reversibility, and electrochemical cycling charge and discharge capacity. For example, in a case of a metal active material, metal powder may crack as drastic expansion and contraction in a lattice volume of metal are repeated. Thus, the cracking may cause a size of powder particles to be fine, so as to induce growth of a solid electrolyte interface layer, which may be problematic. One of the most basic reasons for the problem is that as cycles repeat, deposition of Li ions may not be uniform during a recharge process.

An embodiment provides a negative active material for a rechargeable lithium battery having high capacity and excellent life-cycle characteristics.

Another embodiment provides a rechargeable lithium battery including the negative active material.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A negative active material for a rechargeable lithium battery, the negative active material comprising:
a metal-based active material; and
a solid electrolyte having an ion conductivity of about 1.0×10⁻⁴ S/cm or greater.

2. The negative active material as claimed in claim 1, wherein the solid electrolyte has an ion conductivity of about 1.0×10⁻⁴ S/cm to about 4.0×10⁻³ S/cm.

3. The negative active material as claimed in claim 1, wherein the solid electrolyte includes at least one represented by the following Chemical Formulae 1 to 5:
LiₐX_{b}Y_{c}Z_{d}Oₑ [Chemical Formula 1]
wherein, in Chemical Formula 1,
X is Zn, Sr, La, Pr, Nd, Eu, Sm, Ta, Ba, Ca, or a combination thereof,
Y is Sr, Sb, Nb, Ti, Al, Mg, La, F, Si, B, Ge, O, or a combination thereof
Z is In, Mg, W, Al, V, P, Si, or a combination thereof, and
a is from 0.1 to 6.0, b is from 0 to 3.0, c is from 0 to 3.0, d is from 0 to 3.0, and e is from 0 to 5.0;
LiₐX_{b}Y_{c}Z_{d}(PO₄)ₑ [Chemical Formula 2]
wherein, in Chemical Formula 2,
X is Zn, Sr, La, Pr, Nd, Eu, Sm, Ta, Ba, Ca, or a combination thereof,
Y is Sr, Sb, Nb, Ti, Al, Mg, La, F, Si, B, Ge, O, or a combination thereof
Z is In, Mg, W, Al, V, P, Si, or a combination thereof, and
a is from 0.1 to 6.0, b is from 0 to 3.0, c is from 0 to 3.0, d is from 0 to 3.0, and e is from 0 to 5.0;
LiₐX_{b}Y_{c}Z_{d}Sₑ [Chemical Formula 3]
wherein, in Chemical Formula 3,
X is P, Ge, Si, As, or a combination thereof,
Y is O, P, Ga, or a combination thereof,
Z is In, Mg, W, Al, V, P, Si, or a combination thereof, and
a is from 0.1 to 6.0, b is from 0 to 3.0, c is from 0 to 3.0, d is from 0 to 3.0, and e is from 0 to 5.0;
LiₐX_{b}Y_{c} [Chemical Formula 4]
wherein, in Chemical Formula 4,
X is N, β-Al₂O₃, Cd, I, P, or a combination thereof,
Y is Cl, Br, N, or a combination thereof, and
a is from 0.1 to 6.0, b is from 0 to 3.0, and c is from 0 to 3.0; and
NₐX_{b}Y_{c}Z_{d}Oₑ [Chemical Formula 5]
wherein, in Chemical Formula 5,
X is Zn, Sr, La, Pr, Nd, Eu, Sm, Ta, Ba, Ca, or a combination thereof,
Y is Sr, Sb, Nb, Ti, Al, Mg, La, F, Si, B, Ge, O, or a combination thereof,
Z is In, Mg, W, Al, V, P, Si, or a combination thereof, and
a is from 0.1 to 6.0, b is from 0 to 3.0, c is from 0 to 3.0, d is from 0 to 3.0, and e is from 0 to 5.0.

4. The negative active material as claimed in claim 1, wherein the metal-based active material includes:
Si,
a Si-Q alloy in which Q is an element including an alkali metal, an alkaline-earth metal, a Group 13 element, a Group 13 element, a transition element, a rare earth element, or a combination thereof, and is not Si,
Sn,
Sn—R in which R is an element including an alkali metal, an alkaline-earth metal, a Group 13 element, a Group 13 element, a transition element, a rare earth element, or a combination thereof, and is not Sn, or
a combination thereof.

5. The negative active material as claimed in claim 1, wherein the solid electrolyte is mixed with the metal-based active material.

6. The negative active material as claimed in claim 1, wherein a surface of the metal-based active material is coated with the solid electrolyte.

7. The negative active material as claimed in claim 1, wherein the metal-based active material has an average particle size of about 100 nm to about 15 μm.

8. The negative active material as claimed in claim 1, wherein the solid electrolyte has an average particle size of about 100 nm to about 500 nm.

9. The negative active material as claimed in claim 1, wherein a mixing ratio of the metal-based active material to the solid electrolyte is about 99.99:0.01 wt % to about 70:30 wt %.

10. A rechargeable lithium battery, comprising:
a negative electrode including a negative active material;
a positive electrode including a positive active material; and
a non-aqueous electrolyte,
wherein the negative active material includes a metal-based active material and a solid electrolyte, the solid electrolyte having an ion conductivity of about 1.0×10⁻⁴ S/cm or greater.

11. The rechargeable lithium battery as claimed in claim 10, wherein the solid electrolyte has an ion conductivity of about 1.0×10⁻⁴ S/cm to about 4.0×10⁻³ S/cm.

12. The rechargeable lithium battery as claimed in claim 10, wherein the solid electrolyte includes at least one represented by the following Chemical Formulae 1 to 5:
LiₐX_{b}Y_{c}Z_{d}Oₑ [Chemical Formula 1]
wherein, in Chemical Formula 1,
X is Zn, Sr, La, Pr, Nd, Eu, Sm, Ta, Ba, Ca, or a combination thereof,
Y is Sr, Sb, Nb, Ti, Al, Mg, La, F, Si, B, Ge, O, or a combination thereof
Z is In, Mg, W, Al, V, P, Si, or a combination thereof, and
a is from 0.1 to 6.0, b is from 0 to 3.0, c is from 0 to 3.0, d is from 0 to 3.0, and e is from 0 to 5.0;
LiₐX_{b}Y_{c}Z_{d}(PO₄)ₑ [Chemical Formula 2]
wherein, in Chemical Formula 2,
X is Zn, Sr, La, Pr, Nd, Eu, Sm, Ta, Ba, Ca, or a combination thereof,
Y is Sr, Sb, Nb, Ti, Al, Mg, La, F, Si, B, Ge, O, or a combination thereof
Z is In, Mg, W, Al, V, P, Si, or a combination thereof, and
a is from 0.1 to 6.0, b is from 0 to 3.0, c is from 0 to 3.0, d is from 0 to 3.0, and e is from 0 to 5.0;
LiₐX_{b}Y_{c}Z_{d}Sₑ [Chemical Formula 3]
wherein, in Chemical Formula 3,
X is P, Ge, Si, As, or a combination thereof,
Y is O, P, Ga, or a combination thereof,
Z is In, Mg, W, Al, V, P, Si, or a combination thereof, and
a is from 0.1 to 6.0, b is from 0 to 3.0, c is from 0 to 3.0, d is from 0 to 3.0, and e is from 0 to 5.0;
LiₐX_{b}Y_{c} [Chemical Formula 4]
wherein, in Chemical Formula 4,
X is N, β-Al₂O₃, Cd, I, P, or a combination thereof,
Y is Cl, Br, N, or a combination thereof, and
a is from 0.1 to 6.0, b is from 0 to 3.0, and c is from 0 to 3.0; and
NₐX_{b}Y_{c}Z_{d}Oₑ [Chemical Formula 5]
wherein, in Chemical Formula 5,
X is Zn, Sr, La, Pr, Nd, Eu, Sm, Ta, Ba, Ca, or a combination thereof,
Y is Sr, Sb, Nb, Ti, Al, Mg, La, F, Si, B, Ge, O, or a combination thereof,
Z is In, Mg, W, Al, V, P, Si, or a combination thereof, and
a is from 0.1 to 6.0, b is from 0 to 3.0, c is from 0 to 3.0, d is from 0 to 3.0, and e is from 0 to 5.0.

13. The rechargeable lithium battery as claimed in claim 10, wherein the metal-based active material includes:
Si,
a Si-Q alloy in which Q is an element including an alkali metal, an alkaline-earth metal, a Group 13 element, a Group 13 element, a transition element, a rare earth element, or a combination thereof, and is not Si,
Sn,
Sn—R in which R is an element including an alkali metal, an alkaline-earth metal, a Group 13 element, a Group 13 element, a transition element, a rare earth element, or a combination thereof, and is not Sn, or
a combination thereof.

14. The rechargeable lithium battery as claimed in claim 10, wherein the solid electrolyte is mixed with the metal-based active material.

15. The rechargeable lithium battery as claimed in claim 10, wherein a surface of the metal-based active material is coated with the solid electrolyte.

16. The rechargeable lithium battery as claimed in claim 10, wherein the metal-based active material has an average particle size of about 100 nm to about 15 μm.

17. The rechargeable lithium battery as claimed in claim 10, wherein the solid electrolyte has an average particle size of about 100 nm to about 500 nm.

18. The rechargeable lithium battery as claimed in claim 10, wherein a mixing ratio of the metal-based active material to the solid electrolyte is about 99.99:0.01 wt % to about 70:30 wt %.
